(19) United States
(12) Patent Application Publication
(10) Pub. No.: US 2021/0325001 A1
(43) Pub. Date: Oct. 21, 2021

(54) CONNECTION DEVICE FOR A GAS PRESSURE CHAMBER

(71) Applicant: Franke Technology and Trademark Ltd, Hergiswil (CH)

(72) Inventors: Markus LEUTWILER, Villmergen (CH); Manuel KEEL, Wildegg (CH)

(73) Assignee: Franke Technology and Trademark Ltd, Hergiswil (CH)

(21) Appl. No.: 17/270,229

(22) PCT Filed: Aug. 16, 2019
(86) PCT No.: PCT/EP2019/072044

§ 371 Date: Feb. 22, 2021

(30) Foreign Application Priority Data
Aug. 24, 2018 (EP) 18190710.6

(51) Int. Cl. F17C 13/04

(52) U.S. Cl. CPC F17C 13/04; F17C 2201/058; F17C 2205/037; F17C 2270/0736; F17C 2223/0123; F17C 2223/035; F17C 2221/013

(57) ABSTRACT

In a connection device for coupling a gas pressure container provided with a connection coupling there is provided a guide device which is pivotable about a pivot axis between first and second pivoted positions, wherein the guide device includes an opening for inserting the gas pressure container in an insertion direction extending radially with respect to the pivot axis. A plug nipple is rigidly arranged on the connection device and projects into an inner region of the guide device such that the longitudinal axis of the nipple extends radially relative to the pivot axis and is situated parallel to the insertion direction in the first pivoted position of the guide device. The gas pressure container possesses a connection coupling with a rotationally symmetrical valve body having a coupling opening for receiving the plug nipple. The valve body is mounted within a coupling housing for rotation about an axis of rotation extending perpendicularly to the center axis of the coupling opening and has its outer circumferential surface sealingly mounted to an inner wall of the coupling housing. An outlet bore in the valve body communicates with the coupling opening and, in a second rotational position of the valve body, is in fluidic connection with the pressure container.

### TECHNICAL FIELD

The present invention relates to a connection device for coupling a gas pressure container which is provided with a connection coupling and is intended for storing pressurized gases, in particular carbon dioxide. The invention also relates to a corresponding gas pressure container provided with a connection coupling.

### BACKGROUND

CO₂-filled gas pressure containers are used in drinking-water carbonators, which serve to enrich drinking water with CO₂. In the case of known systems, the gas pressure container is provided on the connection side with an external thread, which is screwed into a corresponding connection part on the drinking-water carbonator. A pin which is arranged centrally on the connection part pushes in a valve tappet at the connection of the gas pressure container, and therefore the valve located on the gas pressure container opens.

It is increasingly the case that drinking-water carbonators are also available in the form of permanently installed appliances which are installed beneath the kitchen worktop, in the region of the drinking-water supply lines. Confined space conditions mean that the task of fitting or changing over a gas pressure container in such appliances is laborious and awkward, and also susceptible to operational errors during the fitting operation.

### SUMMARY

It is therefore the object of the present invention to specify a more easily operable connection device which is intended for coupling a gas pressure container provided with a connection coupling and simplifies the tasks of fitting and changing over the gas pressure container and is suitable, in particular, for use with permanently installed under-unit appliances. The intention is also to specify an associated gas pressure container having a corresponding connection coupling.

The object is achieved by a connection as well as a gas pressure container having one or more features as described herein. Advantageous configurations can be gathered from following description and claims.

In the case of a connection device for coupling a gas pressure container provided with a connection coupling, the invention provides a guide device, which can be pivoted about a pivot axis between a first pivot position and a second pivot position, wherein, at its end which is directed away from the pivot axis, the guide device has an opening which is designed so that the gas pressure container which is to be coupled can be introduced in an introduction direction which runs radially in relation to the pivot axis. Moreover, the connection device has arranged rigidly on it a plug-in nipple, which projects into an inner region of the guide device such that its longitudinal axis runs in the radial direction in relation to the pivot axis of the guide device and, in the first pivot position of the guide device, is located parallel to the introduction direction.

In the first pivot position, it is thus possible for a gas pressure container to be introduced in axial direction into the guide device. Since the longitudinal axis of the plug-in nipple is located in the introduction direction, said nipple can be coupled into a corresponding coupling opening which is formed on the gas pressure container and belongs to a connection coupling provided there. Together with the pressure container which has been introduced, the guide device is then pivoted into the second pivot position. This results in the gas pressure container being arrested within the guide device.

The operation of inserting a new gas pressure container into the connection device therefore takes place in a particularly straightforward manner by virtue of the gas pressure container simply being plugged into the guide device (first pivot position) and being pivoted into the arresting position (second pivot position).

A preferred embodiment makes provision for the guide device to have rotation-prevention means which prevents rotation of the coupled gas pressure container about the longitudinal axis of the latter in relation to the connection device. This rotation-prevention means takes account of the fact that users of conventional connection devices for gas cartridges are accustomed to a screw-thread connection and can be misled thereby, even in the case of a connection device according to the invention, into wanting to rotate a gas cartridge once inserted. This is prevented by a rotation-prevention means, incorrect operation or damage due to excessive application of force being reliably prevented as a result.

The rotation-prevention means is preferably formed by at least one flattened inner wall of the guide device, said inner wall interacting with a correspondingly flattened side wall in the connection region of the gas pressure container.

The guide device can be designed in shell form or at least half-shell form, and therefore it accommodates the front connection region of a gas pressure container and at least partially encloses the same. This ensures reliable guidance when a gas pressure container is being plugged in, and the gas pressure container is thereby reliably retained in the arrested, second pivot position.

The plug-in nipple on the connection device is preferably designed such that it has a tapered neck region. On this neck region, the plug-in nipple can be retained, and arrested, on the gas pressure container within a corresponding connection coupling. Therefore, in the case of a preferred embodiment, the gas pressure container is arrested via the plug-in nipple.

Provision can also be made for the guide device to have at least one end stop, which limits the pivoting range of the guide device in the first pivot position and/or the second pivot position. In particular in the first pivot position, in which the guide device has preferably been pivoted forward in order for a gas pressure container to be introduced, such an end stop is advantageous since it reliably defines the position in which the longitudinal axis of the plug-in nipple is located parallel to the introduction direction. In the second pivot position, the guide device is preferably oriented in a vertically downward direction, whereas, in the first pivot position, it has been pivoted forward by an angle ranging from 30° to 90°, in order to allow straightforward introduction of a gas pressure container.

A pressure-reducing valve which is connected to the plug-in nipple in a fluid-conducting manner can additionally be integrated in the connection device. Such a pressure-reducing valve, which in the case of conventional gas pressure containers is usually fitted externally, allows reliable operation at a constant pressure adapted to the particular application. In the case of a preferred embodiment, the connection device comprises a base unit, on which the pressure-reducing valve is arranged and which is designed so that a gas pressure which prevails at the plug-in nipple can be set to a constant value. The pressure-reducing valve further preferably has a housing, the plug-in nipple being screwed into the same or arranged thereon. This gives rise to a compact, space-saving unit.

A gas pressure container which serves to store pressurized gases and is designed for use with the above-described connection device has a connection coupling which has a rotationally symmetrical valve body, which has a coupling opening for accommodating a plug-in nipple which is suitable and/or designed for use with the connection coupling. The connection coupling also comprises a coupling housing, which is fitted on the gas pressure container and within which the valve body is mounted such that it can be rotated about an axis of rotation running perpendicularly to the center axis of the coupling opening and such that its outer circumferential surface provides sealing action in relation to an inner wall of the coupling housing.

The valve body is of preferably cylindrical design, since the cylinder shape allows straightforward assembly of the connection coupling. As an alternative, however, the valve body can also be of any desired rotationally symmetrical shape, for example a spherical or barrel shape, so that it can be mounted for rotation about its axis of rotation.

The valve body contains an outlet bore, which communicates with the coupling opening and which, in a second rotary position of the valve body, is in fluid-conducting connection with the pressure container. The connection coupling therefore serves, at the same time, as a shut-off valve which, in the first rotary position of the valve body, is closed and, in the second rotary position of the valve body, is open. In the first rotary position, the gas pressure container can therefore be plugged onto a plug-in nipple, provided on a connection device and can then be pivoted in relation to the plug-in nipple, as a result of which the valve body is rotating into its second rotary position, in which a fluid connection between the connection coupling and the plug-in nipple introduced therein is freed in relation to the gas pressure container.

In a first rotary position of the valve body, it is possible for the outlet bore either to be closed with sealing action by the inner wall of the coupling housing or—the preferred scenario here—to be connected to an outwardly directed relief bore in the coupling housing. The latter scenario ensures that any residual pressure contained in the lines connected to the gas pressure container is emptied in a controlled manner prior to the gas pressure container being removed. The only essential factor is that, in the first rotary position, the outlet bore should not be in fluid-conducting connection with the interior of the gas pressure container, and therefore an escape of gas from the gas pressure container is blocked.

In the case of a further preferred embodiment, the coupling housing contains a guide track, over which the coupling opening of the valve body passes as the valve body rotates from the first to the second rotary position and which, in the first rotary position of the valve body, has an opening extent, in the region of the coupling opening, which corresponds at least to that of the coupling opening and which, further along its course to the position of the coupling opening in the second rotary position, has an opening extent which is smaller in the transverse direction and corresponds at least to the diameter of a tapered neck region of the plug-in nipple which can be used with the connection coupling. Therefore, when the valve body is pivoted into the second rotary position, a plug-in nipple introduced into the coupling opening is arrested in the narrowing guide track and secured against being pulled out. Therefore, in the second rotary position, in which the valve body frees the fluid connection to the gas pressure container, release of the plug-in connection between the connection coupling and the plug-in nipple is prevented. Moreover, the plug-in nipple can retain, and arrest, the gas pressure container on a connection device, which partially accommodates or supports the gas pressure container.

In the case of a further preferred embodiment, the gas pressure container is of elongate, for example cylindrical, form, and the coupling housing is fitted in the direction of the longitudinal axis of the gas pressure container, wherein, in the first rotary position of the valve body, that is to say in the closed valve position, the coupling opening, which is formed in the valve body, is oriented colinearly in relation to, or parallel to, the longitudinal axis of the gas pressure container. It is thus possible for the gas pressure container to be pushed in the direction of its longitudinal axis into a guide device of a connection device and, at the same time, plugged onto a plug-in nipple provided there, since the center axis of the coupling opening, into which the plug-in nipple is plugged into the connection coupling on the gas pressure container, coincides with the longitudinal axis of the gas pressure container. This allows particularly easy-to-handle and user-friendly coupling of the gas pressure container to a connection device.

The gas pressure container preferably has a connection head or connection neck, which supports the coupling housing, for example a tapering connection region of an otherwise cylindrical pressure container. Moreover, a pressure-relief valve is preferably integrated here either in the coupling housing itself or in the connection region of the gas pressure container. Such a pressure-relief valve serves as a safety valve and, in the event of an extreme increase in temperature causing the internal pressure to be increased to a critical value of, for example, 200 bar, allows pressure to escape, in order to avoid the gas pressure container rupturing.

The gas pressure container is preferably designed in the form of a conventional gas cartridge or gas bottle, as a cylindrical hollow body with a region which tapers in the direction of a connection head, which supports the coupling housing.

The coupling housing, which is arranged on the gas pressure container or the connection head thereof, or the connection head of the gas pressure container itself are designed here preferably with a rotation-prevention means which prevents rotation of the gas pressure container about the longitudinal axis of the latter in relation to a connection device which accommodates the coupling housing.

As already explained above, this takes into account the fact that users of conventional gas bottles/gas cartridges are accustomed to coupling these to a connection device via a screw connection. The rotation-prevention means therefore prevents incorrect operation or damage by users attempting to rotate a gas pressure container according to the invention.

Furthermore, the gas pressure container can be equipped with a rapid-emptying prevention valve, which, in the event of gas flowing out freely via the connection coupling, should the latter be opened accidentally, suppresses the outflow or at least throttles the gas flow. Therefore, in the event of the connection coupling being subjected to improper manipulation which rotates the valve body, without a plug-in nipple introduced into the same, into its open position, an excessive escape of gas is prevented, and this therefore avoids damage as a result of a rebound effect or extreme cooling of the expanding gas.

Such a rapid-emptying-prevention valve can be formed, for example, by a shutting body, which, in its closed position, is retained by gas pressure against a through-passage opening of the rapid-emptying-prevention valve, and also by a spring element, which forces the shutting body into its open position away from the through-passage opening.

In the case of an alternative embodiment, rapid emptying is prevented by a narrow through-opening, which reduces gas flow. Provision is preferably made here, however, of a non-return valve which opens counter to the outflow direction and opens in order for the gas pressure container to be filled. The through-opening here can be formed in the valve seat of the non-return valve.

As a further means of protecting against manipulation of the connection coupling, it is possible for the valve body to have provided on it a shutting member which is retained by spring force in a shutting position, in which it blocks rotation of the valve body, and which is moved into an opening position by a plug-in nipple introduced into the coupling opening. This means that the valve body can only be moved into its second rotary position, the open position, when a plug-in nipple has been plugged in. The rotation-prevention means can be improved further by the plug-in nipple being provided with a depression of predetermined depth, the depression interacting with the shutting member. Similar to a pin tumbler in a cylinder lock, the valve body can rotate only when the shutting member is held back by the extent predetermined by the depression on the plug-in nipple.

The invention further relates to an arrangement comprising a connection device and, coupled thereto, a gas pressure container of the type above, wherein the pivot axis of the guide device of the connection device and the axis of rotation of the valve body in the connection coupling of the gas pressure container coincide. This gives rise to smooth, jamming-free actuation of the valve body in the connection coupling when the gas pressure container inserted into the connection device is pivoted.

### BRIEF DESCRIPTION OF THE DRAWINGS

Further advantages and properties of the present invention can be gathered from the following description of exemplary embodiments with reference to the figures, in which:

FIG. 1 shows a gas pressure container being introduced into a guide device of a connection device,

FIG. 2 shows the gas pressure container from FIG. 1 pushed into the guide device, in a first pivot position,

FIG. 3 shows the gas pressure container from FIG. 1 introduced into the connection device, in a second, locked pivot position,

FIG. 4 shows a lateral section through the gas pressure container and connection device from FIG. 2,

FIG. 5 shows a lateral-section drawing of the gas pressure container and connection device from FIG. 3,

FIG. 6 shows an enlarged-section drawing of the connection between the gas pressure container and connection device in the first pivot position,

FIG. 7 shows an enlarged-section drawing of the connection between the gas pressure container and connection device in the second pivot position,

FIG. 8A shows a longitudinal section through a first exemplary embodiment of a connection coupling for a gas pressure container having a rapid-emptying-prevention valve,

FIG. 8B shows a longitudinal section through the connection coupling from FIG. 8A in a section plane perpendicular to FIG. 8A,

FIG. 9 shows a longitudinal section of a second exemplary embodiment of a connection coupling for a gas pressure container, having a rapid-emptying-prevention means and rapid-filling function,

FIG. 10 shows a longitudinal section through a further exemplary embodiment of a connection coupling, having a rotation-blocking means for the valve body,

FIG. 11 shows a detail of the section from FIG. 10, with the valve body opened by a plug-in nipple having been plugged in, and

FIG. 12 shows the detail from FIG. 11, with the valve body shut, the plug-in nipple pulled out.

### DETAILED DESCRIPTION

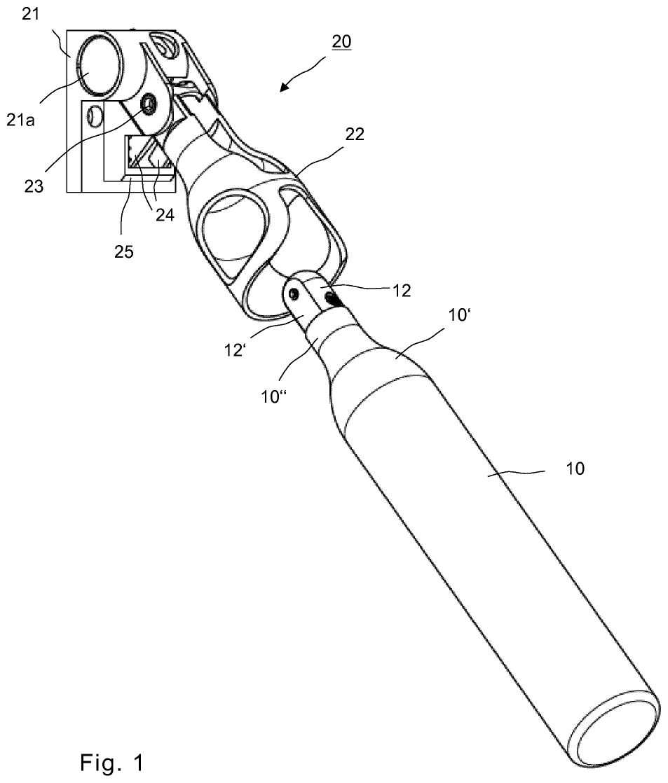

FIG. 1 depicts a gas pressure container in the form of an essentially cylindrical gas cartridge 10 together with a connection device 20, which serves to couple the gas cartridge 10. In the direction of its connection, the gas cartridge 10 has a tapering neck region 10′, which opens out in a connection head 10″. The latter has a connection opening, which is provided with an internal thread onto which is screwed a connection coupling 12, the function of which will be explained in more detail hereinbelow.

The connection device 20 has a base plate 21, which is fitted on an appliance which is to be supplied with gas, for example a CO₂ carbonator, and a guide device 22, which is connected to the base plate 21 in an articulated manner and is designed in the form of a shell, the exemplary embodiment partially skeletonized, for accommodating the front, outlet region of the gas cartridge 10. An articulation 23, which is fitted on the base plate 21, defines the pivot axis of the guide device 22. Together with a protrusion 25, which is arranged on the base plate 21, two extensions 24, which project rearward from the guide device 22, form an end stop, which limits the pivoting movement of the guide device 22 in the position in which it has been pivoted out in a forward direction.

Also arranged on the base plate 21 is a pressure-reducing valve 21a, which serves to set the gas pressure at the outlet of the gas cartridge 10 to a constant value. In the case of a pressure-reducing valve 21a, the initial pressure at the valve is fed back to a control input and ensures that, when the predetermined or set desired initial pressure is exceeded, the valve shuts and the initial pressure therefore cannot increase above this pre-set value. A piston or a membrane can be used here in the form of a pressure transducer. Such pressure-reducing valves are known per se to a person skilled in the art.

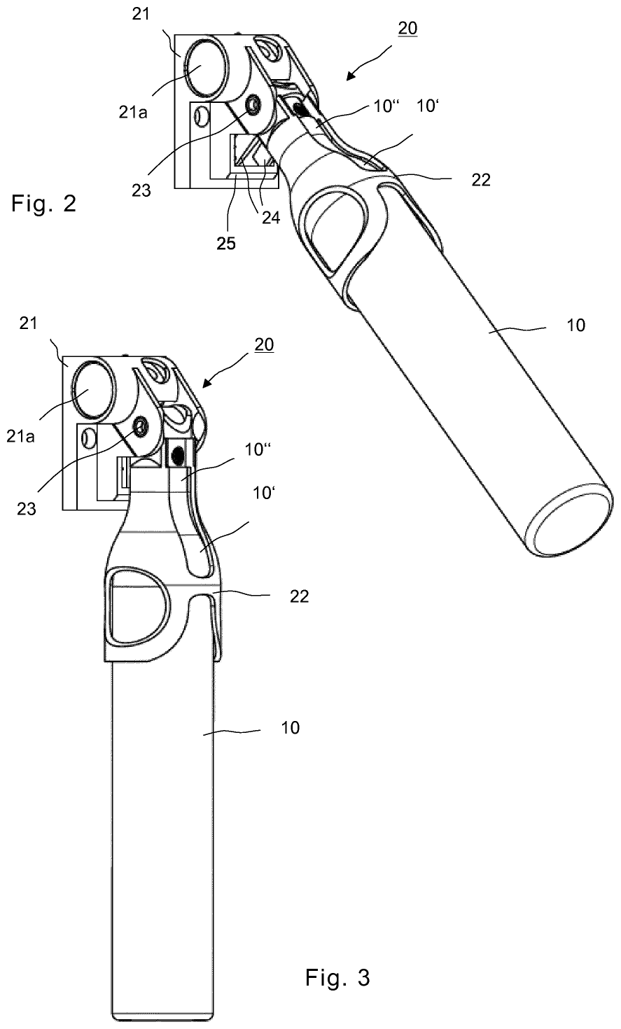

FIG. 1 illustrates the guide device 22 in the pivoted-out state—the first pivot position—, in which the gas cartridge 10 can be introduced in the axial direction, that is to say in the longitudinal direction of the gas cartridge 10, into the guide device 22. In the exemplary embodiment, the angle by which the guide device 22 has been pivoted out is approximately 45°. FIG. 2 shows the state once the gas cartridge 10 has been introduced all the way into the guide device 22, but is still located in its pivoted-out state, the first pivot position.

Once the gas cartridge 10 has been introduced into the guide device 22, the gas cartridge 10, together with the guide device 22, is pivoted downward, about the pivot axis formed by the hinge 23, into a vertical position, the second pivot position. This is illustrated in FIG. 3.

In the second pivot position, the gas cartridge 10, as will be explained in more detail hereinbelow, is arrested in the guide device 22 and connected in a fluid-conducting manner to a gas line (concealed in the Figures) which opens out in the connection device 20 and leads away rearward to an appliance. A valve which is integrated in the connection coupling 12 of the gas cartridge 10 is located in the open state, and therefore gas can flow out of the gas cartridge 10, via the connection device 20, to a connected consuming unit.

For this purpose, a plug-in nipple 26 is arranged in the inner region of the connection device 20, in the region of the pivot axis. When the gas cartridge 10 is being pushed in, the plug-in nipple 26 penetrates into a coupling opening provided on the connection coupling 12 and is accommodated with sealing action therein. When the gas cartridge 10 is pivoted into the second pivot position, the plug-in nipple 26 remains rigid and does not pivot along with the guide device 22.

In the exemplary embodiment, the plug-in nipple 26 is screwed directly into the housing of the pressure-reducing valve 21a or arranged thereon. The pressure-reducing valve 21a, in turn, is integrated in the base unit 21, designed for example in the form of a plastic molding, or accommodated therein, this resulting in a compact, space-saving unit.

The two side surfaces 12′ of the connection coupling 12 are in a flattened state, and therefore, in a correspondingly profiled mount in the guide device 22, they form a rotation-prevention means, which prevents the gas cartridge from being capable of rotation in the guide device 22.

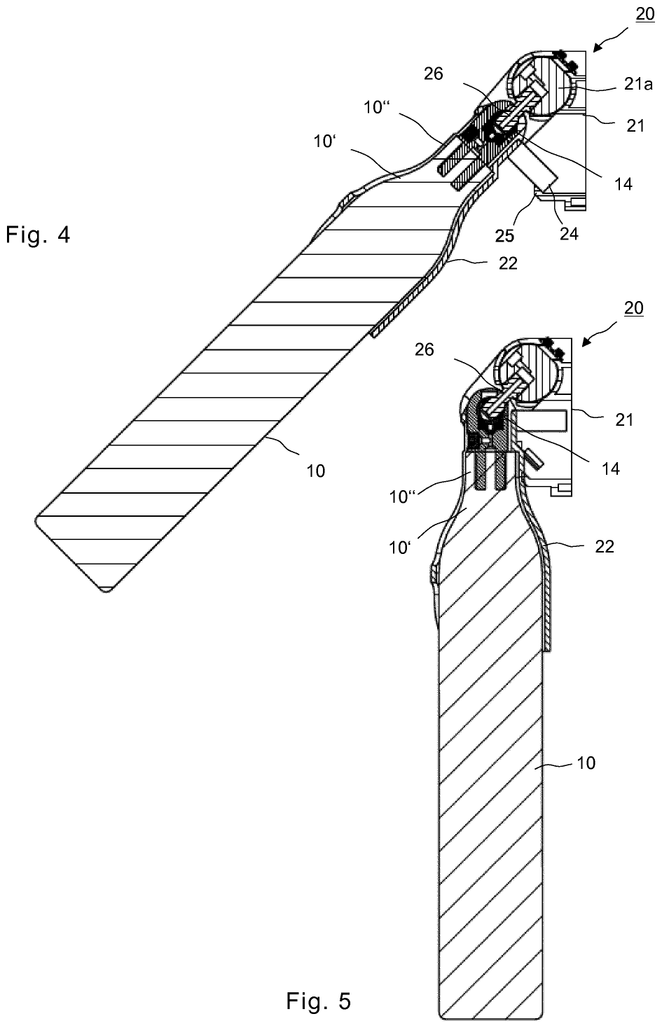

The sectional images of FIGS. 4 and 5 illustrate the plug-in nipple 26 and the orientation thereof in relation to the gas cartridge 10, which has been pushed in and then pivoted. When the gas cartridge 10 is pivoted, the plug-in nipple 26 rotates a valve body 14, which is contained in the connection coupling 12, as a result of which the valve integrated in the connection coupling 12 is opened, and therefore gas can flow out of the gas cartridge 10, via the plug-in nipple 26, to the connection device 20.

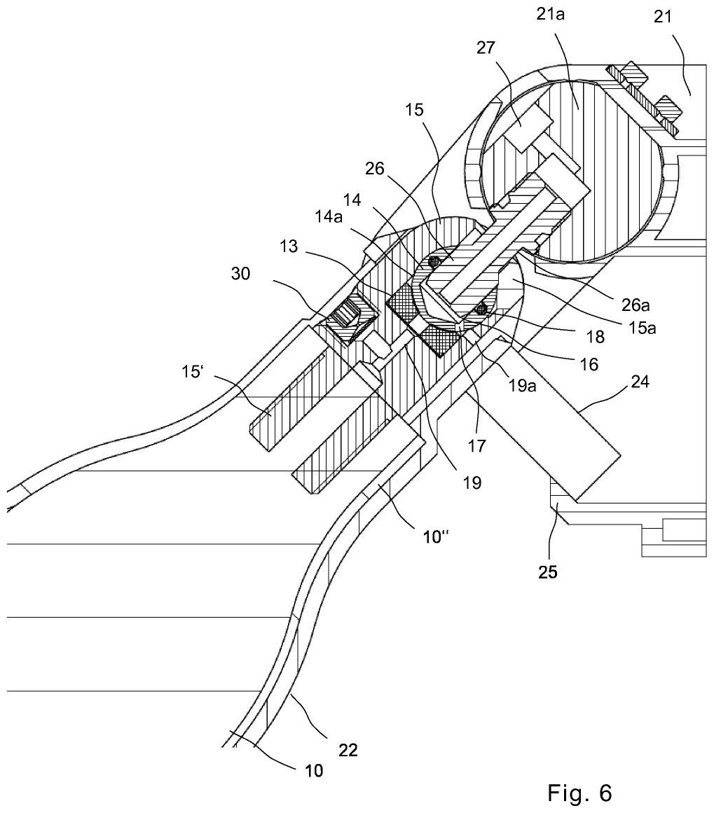

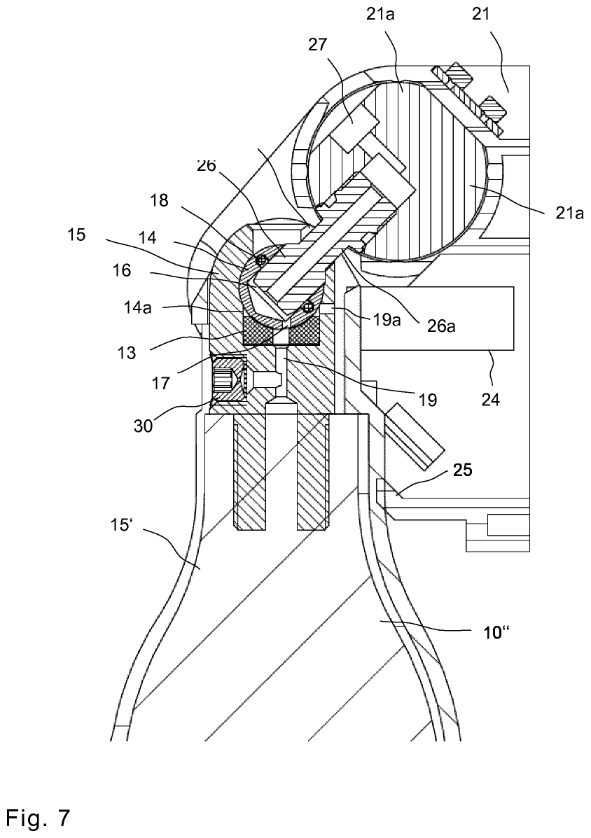

FIGS. 6 and 7 illustrate the connection coupling 12, and the connection thereof to the connection device 20, in more detail. The connection coupling 12 has a coupling housing 15 which has a screw connection 15′ with an external thread, by means of which it is screwed onto the neck 10″ of the gas cartridge 10. A cylindrical valve body 14 is accommodated in an aperture 14a of the housing 15, said aperture being arranged perpendicularly to the longitudinal axis of the gas cartridge 10. Said valve body is mounted such that it can be rotated within the aperture 14a and such that its outer circumferential surface or lateral surface provides sealing action in relation to an inner wall of the aperture 14a in the coupling housing 15.

In its lateral surface, the valve body 14 has a coupling opening in the form of a bore 16, of which the center axis runs perpendicularly to the axis of rotation of the valve body 14. The coupling opening 16 serves as a mount for the plug-in nipple 26, which is arranged on the connection device 20. In order to ensure sealing of the plug-in nipple 26 within the coupling opening 16, a seal 18 is positioned in an annular groove running on the inside of the coupling opening 16.

In its lower region, the coupling opening 16 tapers conically and, when the plug-in nipple 26 has been introduced, forms a chamber in front of said nipple. An outlet bore 17, which leads in the direction of the inner wall of the coupling housing 15, opens out into said chamber. The coupling housing 15 contains a flow channel 19, which leads from the valve body 14 or the aperture 14a into the inner region of the gas cartridge 10. In addition, a seal, for example an elastomer seal 13, can be inserted in the region of the flow channel 19, and seals the valve body 14 in relation to the inner wall of the aperture 14a.

In that rotary position of the valve body 14 which is shown in FIG. 6, and in which the plug-in nipple 26 can be introduced in the longitudinal direction of the gas cartridge 10 into the coupling opening 16, which is formed in the valve body 14, said channel 19 has been closed with sealing action by the valve body 14. There is therefore no fluid-conducting connection with the interior of the gas cartridge 10. The outlet bore 17 in the valve body 14 is vented in the outward direction via a lateral bore 19a in the coupling housing 15, and therefore any residual pressure which is present in the plug-in nipple 26 and in lines connected thereto can escape in a controlled manner prior to the gas cartridge 10 being uncoupled.

If the gas cartridge 10, as shown in FIGS. 6 and 7, has been pushed all the way into the guide device 22, then the axis of rotation of the valve body 14 and the pivot axis of the guide device 22 coincide and allow a joint rotary/pivoting movement. When the gas cartridge 10, which is coupled to the plug-in nipple 26, is pivoted, the cylindrical valve body 14 is therefore rotated in relation to the coupling housing 15, and therefore the outlet bore 17 opens out into the channel 19. This second rotary position is illustrated in FIG. 7. In this position, there is a fluid-conducting connection from the interior of the gas cartridge 10, via the channel 19 and the bore 17, into the interior of the coupling opening 16 and to the plug-in nipple 26, which has been introduced. It is therefore possible, via the connection device 20, for gas to be removed from the gas cartridge 10 and fed to a connected consuming unit, for example a drinking-water carbonator.

In the first pivoted position, which is shown in FIG. 6 and in which a gas cartridge 10 can be introduced into the guide device 22 and connected to the plug-in nipple 26, the plug-in nipple 26 is arranged coaxially with the guide device 22. The position of the guide device 22 is defined by the end stop, which is formed by the extension 24, which is fitted on the guide device 22, and the protrusion 25, which is connected to the base plate 21.

A slot-form guide track 15a is formed in the end region of the coupling housing 15 and allows the plug-in nipple 26 to pivot when the valve body 14 is rotated. Along its longitudinal course, the guide track 15a has the contour of a keyhole, with a relatively large, circular opening region. In the first rotary position, which is shown in FIG. 6, this corresponds with the coupling opening, and therefore the plug-in nipple 26 can be introduced.

Further along its course, the guide track 15a has a narrower opening extent in the transverse direction, that is to say in the direction perpendicular to the drawing plane. Correspondingly, on its side which is oriented toward the connection device 20 and projects out of the coupling device 12, the plug-in nipple 26 has a tapered neck region 26a, which fits through the narrower slot formed by the guide track 15a. This means that the plug-in nipple 26 can only be introduced into the coupling opening 16, or pulled out again, in the rotary position which is shown in FIG. 6, that is to say in the direction of the longitudinal axis of the gas cartridge 10. If, in contrast, the guide device 22, together with the gas cartridge 10 inserted therein, is pivoted into the second pivot position, as shown in FIG. 7, then the guide track 15a, which is narrower in this region, arrests the plug-in nipple 26 in the mount 16 of the valve body 14 and thus prevents uncoupling of the gas cartridge 10 in the second pivot position.

The gas cartridge 10 can therefore only be coupled to, and uncoupled again from, the plug-in nipple 26, and therefore the connection device 20, in the closed valve position of the valve body 14, whereas the connection between the gas cartridge 10 and connection device 20 is in a reliably arrested state in the second pivot position.

The connection coupling 12, moreover, is provided with an integrated pressure-relief valve 30. In the case of a temperature-induced increase of the internal pressure in the gas cartridge above a critical value—in the exemplary embodiment above 200 bar—said pressure-relief valve serves to allow the pressure to escape, in order thus to prevent the gas cartridge from rupturing. The pressure-relief or safety valve 30 is formed by a nut and a thin rupture disk, which ruptures in the event of excess pressure and frees an exit opening, via which the gas can escape from the interior of the gas cartridge.

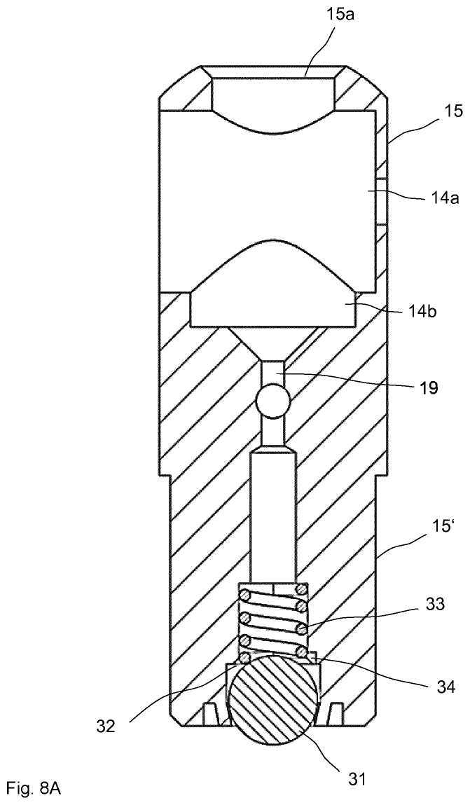

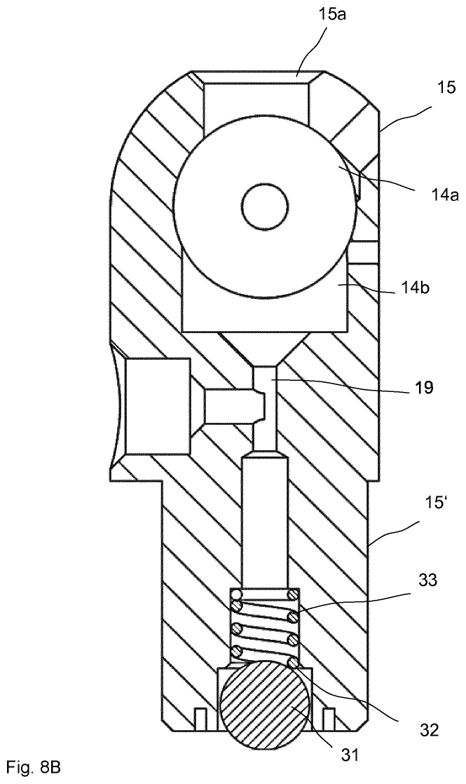

FIGS. 8A and 8B show, as an additional measure, an exemplary embodiment of a connection coupling 12 which is intended for a gas pressure container and in the case of which a non-return valve, which serves as a rapid-emptying-prevention means, is additionally integrated in the coupling housing 15. The plane of the section shown in FIG. 8A runs in the longitudinal direction of the connection coupling, but perpendicularly to the sections shown in FIGS. 6 and 7. The section plane of FIG. 8B corresponds to that in FIGS. 6 and 7.

In the illustration shown in FIGS. 8A and 8B, the cylindrical valve body 14 has not been inserted. The aperture 14a which is provided for this purpose in the housing in the housing 15 is therefore free. For mounting purposes, the valve body 14 is pushed into the aperture 14a from the left-hand side and secured for example by a securing ring. An elastomer seal 13 can be inserted in addition into the installation space 14b located therebeneath.

The non-return or rapid-emptying-prevention valve comprises a shutting body 31, in this case a sphere, which in the closed state butts against a valve seat 32 of the coupling housing 15. A helical spring 33 subjects the sphere 31 to a force which is directed downward, in the opening direction, and therefore retains the sphere 31 in the open position. In this position, gas can flow past the sphere 31 to the outlet of the connection coupling 12. In FIG. 8A, it appears as though, in the open state, the peripheral gap is blocked in the downward direction by the sphere 31. This is due to the two lateral projections, which prevent the sphere from falling out. FIG. 8B shows the free peripheral gap around the sphere 31, it being possible for gas to flow through the non-return valve through said peripheral gap in the open state.

In the event of gas flowing out freely via the open connection coupling 12, the non-return valve, which serves as a rapid-emptying-prevention means, has the function of suppressing the outflow. If no consumer unit has been connected to the connection coupling 12 and the valve has been opened accidentally, then the outflowing gas pushes the valve sphere 31, counter to the spring force of the opening spring 33, against the valve seat 32 and thus reduces the gas flow. During normal operation, there is merely a small difference in pressure in front of and behind the non-return valve, and therefore the force of the opening spring 33 is sufficient to keep the valve sphere 31 in the open state. A small groove 34 in the valve seat 32, said groove serving as a bypass, ensures that, when the valve is in the closed state, that is to say when the valve sphere 31 butts against the valve seat 32, the difference in pressure in front of and behind the non-return valve can be dissipated again, and therefore the spring 33 opens the valve again.

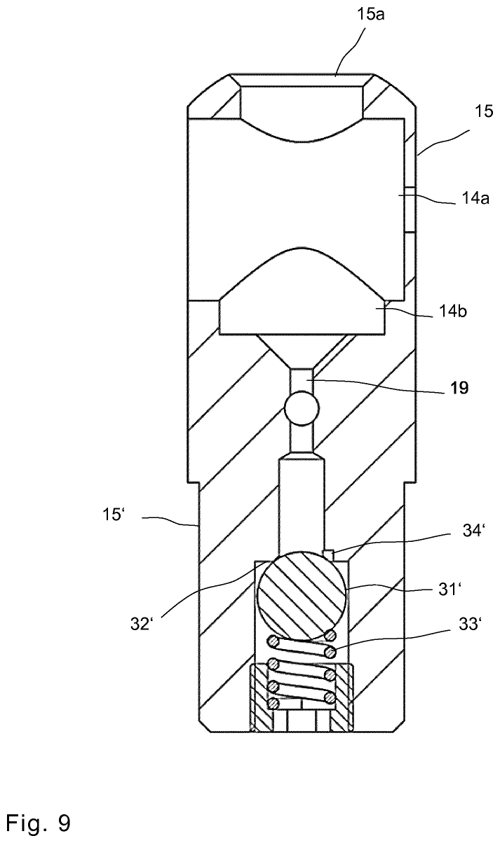

A further exemplary embodiment of a connection coupling 12 having a rapid-emptying-prevention means is shown in FIG. 9. The section plane here runs similarly to FIGS. 8A and 8B. Here too, a valve body in the form of a sphere 31′ is provided, the sphere being retained against a valve seat 32′ in the coupling housing 15. In contrast to the exemplary embodiment which is shown in FIG. 8, however, the spring 33′ is located on the opposite side and exerts a force which retains the valve sphere 31′ against the valve seat 32′. A lateral groove 34′, which is formed in the valve seat 32′, constitutes a narrow flow path, through which during normal operation, when the valve 14 is in the open state, gas can flow in the direction of the outlet. The bypass 34′ therefore serves simply as a narrowing, which, on account of its throttling action, ensures in the case of outflow a sufficient reduction in the gas flow, while during normal operation nevertheless allowing sufficient gas to pass through. The non-return valve, which is formed by the sphere 31′, valve seat 32′ and spring 33′, therefore acts counter to the outflow direction and serves to allow rapid filling of the gas cartridge 10. If external pressure is applied for the purpose of filling the gas cartridge 10, then this pressure lifts the valve sphere 31′ up from its valve seat 32′ and thus increases the size of the flow path, it therefore being possible for an increased gas flow to flow through for the purpose of filling the gas cartridge 10. This gives rise to a reduction in the size of the flow path merely in the outflow direction.

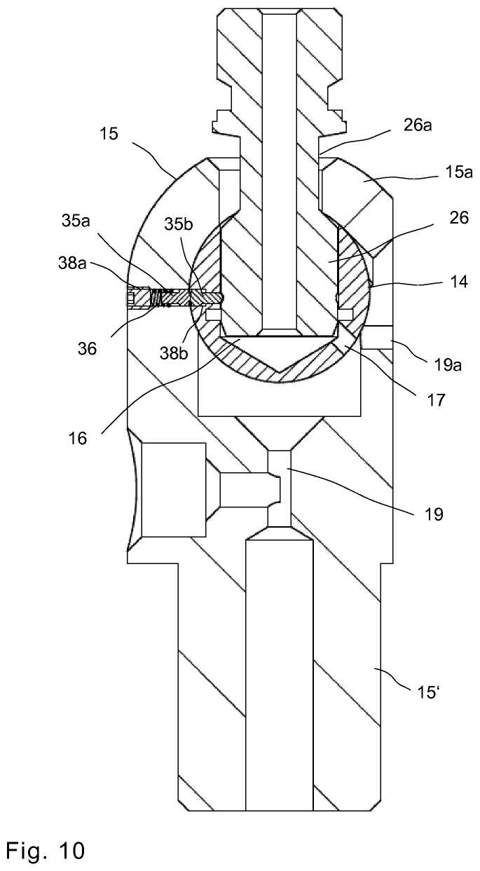

FIGS. 10 to 12 show a further exemplary embodiment of a connection coupling 12. The sections taken here are like those in FIGS. 6 and 7. A rotation-prevention means for the valve body 14 is provided as an additional function here. The rotation-prevention means is formed by a two-part locking pin, the function of which is similar to that of a pin tumbler in a cylinder lock. The left-hand sub-pin 35a is seated in a lateral bore 38 in the coupling housing 15 and is forced by a spring 36 against the valve body 14. The latter has a corresponding bore 38b, into which the second sub-pin 35b has been inserted. In the first rotary position of the valve body 14, said position being shown in FIG. 10, the bores 38a and 38b are in alignment, and therefore the sub-pins 35a, 35b butt against one another at their ends. The sub-pin 35b has a tapered end, which projects into the coupling opening formed by the accommodating bore 16 in the valve body 14.

It can also be seen in FIG. 10 that the coupling housing 15 of the connection coupling is likewise in a flattened state on one side, on the rear side (the right of the Figure), as a rotation-prevention means.

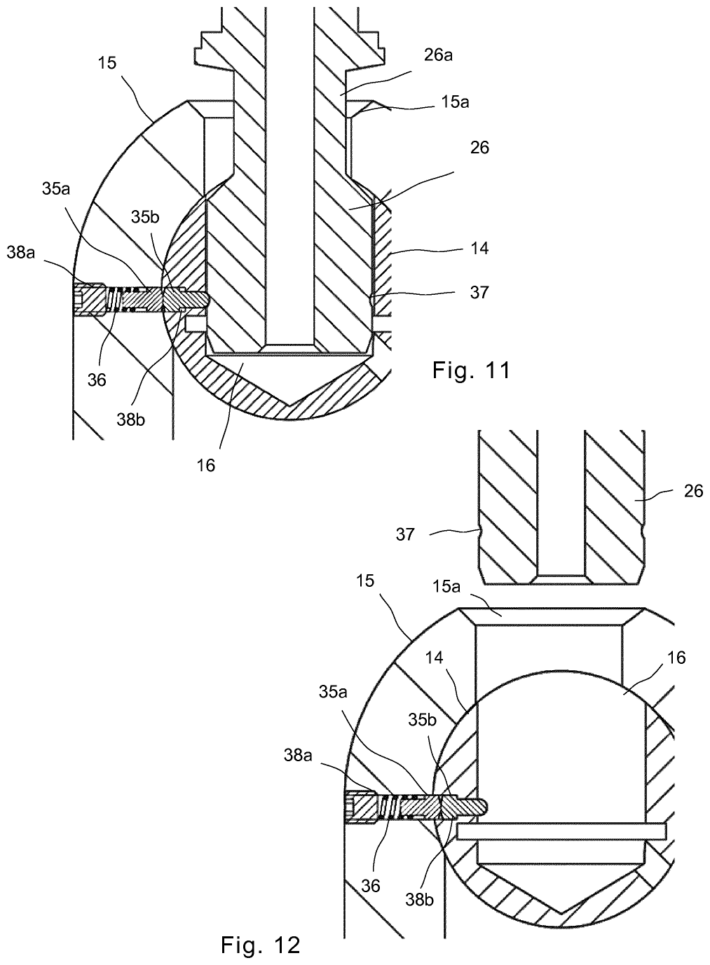

FIGS. 11 and 12 show the locking pins 35a, 35b in the form of an enlarged detail. If the plug-in nipple 26 is pulled out of the coupling opening 16, then the spring 36 pushes the two sub-pins 35a and 35b inward, and therefore the sub-pin 35a projects into the bore 38b in the valve body 14 and blocks a rotary movement of the valve body 14.

The plug-in nipple 26 has an annularly encircling groove or notch 37, which corresponds with the position of the locking pins 35a, 35b. The depth of this groove 37 is dimensioned such that, when the plug-in nipple 26 has been plugged in, the sub-pin 35b is pushed in just far enough for it to keep the sub-pin 35a out of the bore 38b. In this position, the valve body 14 has been opened and can be rotated. If, however, a plug-in nipple 26 without a corresponding notch 37 is introduced, then it pushes the right-hand sub-pin 35b in too far, and therefore said sub-pin penetrates into the bore 38a of the coupling housing 15 and thus, for its part, blocks rotation of the valve body 14. The plug-in nipple 26 with the groove 37 therefore serves as a key for unlocking the rotation-prevention means, it therefore being possible for the rotary movement of the valve body 14 to be unlocked, and freed, only by the appropriate plug-in nipple 26. This prevents manipulation, where for example attempts could be made to open the valve using an object introduced into the coupling opening 16.

1. A connection device (20) for coupling a gas pressure container (10) which is provided with a connection coupling (12) and is intended for storing pressurized gases, the connection device comprising:
a guide device (22), which is pivotable about a pivot axis between a first pivot position and a second pivot position, wherein, at a first end which is directed away from the pivot axis, the guide device (22) has an opening configured so that the gas pressure container (10) which is to be coupled is introducible in an introduction direction which runs radially in relation to the pivot axis, and
a plug-in nipple (26) arranged rigidly on the connection device (20), the plug-in nipple projects into an inner region of the guide device (22) such that a longitudinal axis thereof extends runs in a radial direction in relation to the pivot axis of the guide device (22) and, in the first pivot position of the guide device (22), is located parallel to the introduction direction.

2. The connection device (20) as claimed in claim 1, wherein the guide device (22) has a rotation-prevention feature that prevents rotation of the coupled gas pressure container (10) about a longitudinal axis thereof in relation to the connection device (20), the rotation-prevention feature comprising at least one flattened inner wall of the guide device (22).

3. The connection device (20) as claimed in claim 1, wherein the guide device (22) has a shell form or at least half-shell form.

4. The connection device (20) as claimed in claim 1, wherein the plug-in nipple (26) has a tapered neck region (26a).

5. The connection device (20) as claimed in claim 1, wherein the guide device (22) has at least one end stop, which limits a pivoting range of the guide device in at least one of the first pivot position or the second pivot position.

6. The connection device (20) as claimed in claim 1, further comprising a base unit (21), on which is arranged a pressure-reducing valve (21a) which is configured such that a gas pressure which prevails at the plug-in nipple (26) is settable to a constant value, the pressure-reducing valve (21a) having a housing, and the plug-in nipple (26) being screwed into the housing of the pressure-reducing valve (21a) or being arranged thereon.

7. A gas pressure container (10) for storing pressurized gases, the gas pressure container comprising:
a connection coupling (12) including
a rotationally symmetrical valve body (14), which has a coupling opening (16) for accommodating a plug-in nipple (26) which is adapted for use with the connection coupling (12), and
a coupling housing (15), which is fitted on the gas pressure container (10) and within which the valve body (14) is mounted for rotatable movement about an axis of rotation that extends perpendicularly to a center axis of the coupling opening (16) and such that an outer circumferential surface of the valve body provides sealing action in relation to an inner wall of the coupling housing (15),
wherein the valve body (14) contains an outlet bore (17), which communicates with the coupling opening (16) and which, in a second rotary position of the valve body (14), is in fluid-conducting connection with the gas pressure container (10).

8. The gas pressure container (10) as claimed in claim 7, wherein the coupling housing (15) contains a guide track (15a), over which the coupling opening (16) of the valve body (14) passes as the valve body rotates from a first rotary position to the second rotary position and which, in the first rotary position of the valve body (14), has an opening extent, in a region of the coupling opening (16), which corresponds at least to that of the coupling opening (16) and which, further along a course to the position of the coupling opening (16) in the second rotary position, has an opening extent which is smaller in a transverse direction and corresponds at least to a diameter of a tapered neck region (26a) of the plug-in nipple (26) which is adapted to be used with the connection coupling (12).

9. The gas pressure container (10) as claimed in claim 7, wherein the gas pressure container has an elongate form and the coupling housing (15) is fitted in a direction of a longitudinal axis of the gas pressure container (10) and, in a first rotary position of the valve body (14), the coupling opening (16), which is formed in the valve body (14), is oriented colinearly in relation to, or parallel to, the longitudinal axis of the gas pressure container (10).

10. The gas pressure container (10) as claimed in claim 7, further comprising a connection head (10″), which supports the coupling housing (15), and a pressure-relief valve (30) integrated in the connection head (10″) or the coupling housing (15).

11. The gas pressure container (10) as claimed in claim 10, wherein the gas pressure container has a cylindrical hollow body with a region (10′) which tapers in a direction of a connection head (10″), which supports the coupling housing (15), wherein the coupling housing (15) or the connection head (10″) include a rotation-prevention feature that prevents rotation of the gas pressure container (10) about a longitudinal axis thereof in relation to a connection device (20) which accommodates the coupling housing (15), the rotation-prevention feature including at least one flattened side wall of the coupling housing (15).

12. The gas pressure container (10) as claimed in claim 7, further comprising a rapid-emptying-prevention valve, which, in an event of gas flowing out freely via an open connection coupling (12), suppresses an outflow or at least throttles the gas outflow.

13. The gas pressure container (10) as claimed in claim 12, wherein the rapid-emptying-prevention valve comprises a shutting body (31), which, in a closed position thereof, is configured to be retained by gas pressure against a through-passage opening of the rapid-emptying-prevention valve, and a spring element (33), which is configured to force the shutting body (31) into an open position away from the through-passage opening.

14. The gas pressure container (10) as claimed in claim 12, wherein the rapid-emptying-prevention valve comprises a narrowing and a non-return valve which opens counter to an outflow direction and opens in order for the gas pressure container to be filled.

15. The gas pressure container (10) as claimed in claim 7, wherein the valve body (14) comprises a shutting member which is retained by spring force in a shutting position, in which the shutting member blocks rotation of the valve body (14) and which is adapted to be moved into an open position by a plug-in nipple (26) introduced into the coupling opening (16).

16. The gas pressure container (10) as claimed in claim 14, wherein the narrowing is formed in a valve seat of the non-return valve.
